(19) United States
(12) Patent Application Publication
(10) Pub. No.: US 2008/0057249 A1
(43) Pub. Date: Mar. 6, 2008

(54) Ribbed core multi-wall structure

(76) Inventor: F. John Herrington, Bloomfield, NY (US)

Correspondence Address: INTELLECTURAL PROPERTY LAW OFFICE;MICHAEL G. GILMAN, 424 LANTANA PARK, LEXINGTON, KY, 40515, US

(21) Appl. No.: 11/978,311

(22) Filed: Oct. 29, 2007

Related U.S. Application Data
(63) Continuation of application No. 11/585,698, filed on Oct. 25, 2006.
(63) Continuation-in-part of application No. 10/485,341, filed on Jan. 30, 2004.
Application No. 10/485,341 is a continuation of application No. PCT/US02/24437, filed on Aug. 1, 2002.
Application No. 11/585,698 is a division of application No. 11/154,018, filed on Jun. 17, 2005, now Pat. No. 7,140,859.
Application No. 11/154,018 is a division of application No. 10/139,208, filed on May 7, 2002, now Pat. No. 6,955,780.
Application No. 10/139,208 is a division of application No. 09/626,886, filed on Jul. 27, 2000, now Pat. No. 6,405,974.

(30) Foreign Application Priority Data
Aug. 1, 2002 (US) PCT/US02/24437

(51) Int. Cl. B29C 53/14

(52) U.S. Cl. 428/36.91; 264/209.2

(57) ABSTRACT

A multi-wall, seamless, helical tubular structure comprising, as a single seamless entity, an inner cylindrical element, an outer tubular element spaced radially from the inner cylindrical element; and a plurality of rib elements seamlessly contiguous with said inner and outer elements and in supporting relationship to said inner and outer elements; wherein the structure as a whole and all of the elements thereof are substantially helical in configuration. At least some of the next adjacent rib elements are disposed normal to said inner cylindrical and outer tubular elements whereby, in combination with the intercepted portions of said inner and outer elements, forming generally trapezoidal helical truss cells. One important use of these helical products is as cores for rolled goods such as plastic film or sheeting. An apparatus for producing such a helical tubular structure as a seamless helical entity comprising a rotatable extrusion die assembly comprising an outer rotatable arcuate die portion that corresponds to said outer tubular element, an inner rotatable arcuate die portion that corresponds to said inner cylindrical element and a plurality of rotatable die portions that correspond to said rib elements and communicate with both said inner and outer die portions wherein all of said die elements are adapted to operate together to rotate simultaneously whereby enabling the formation of a unitary, seamless helical extrudate structure configured as aforesaid. The apparatus further comprises means for extruding the helical extrudate formed of moldable plastic through said extrusion die assembly and moving the extrudate in a downstream direction. Still further, the apparatus comprises cooling means operatively associated with said extrudate adapted to cool and solidify said extrudate in said helical configuration. A method of forming the referenced unitary helical structure comprises feeding a molten stream of a moldable plastic through a rotating extrusion die assembly while rotating the extrusion die assembly as a whole to thereby configure the emerging stream of molten plastic as a seamless, unitary, helical tubular extrudate. The helical extrudate is cooled an amount sufficient to freeze and solidify the same whereby freezing the helical structure into the solidified extrudate.

This application is a continuation of application Ser. No. 11/585,698 filed Oct. 25, 2006; and a continuation in part of application U.S. Ser. No. 10/485,341 filed Jan. 30, 2004 that is a continuation of pending international application PCT/US02/24437 filed Aug. 1, 2002 that has a priority date of Aug. 3, 2001. It is also a division of pending U.S. application Ser. No. 11/154,018 filed Jun. 17, 2005, that is a division of U.S. application Ser. No. 10/139,208 filed May 7, 2002, now U.S. Pat. No. 6,955,780; that is a division of U.S. application Ser. No. 09/626,886 filed Jul. 27, 2000, now U.S. Pat. No. 6,405,974, that is derived from PCT application PCT/US99/17172 filed Jul. 29, 1999, that is derived from U.S. application Ser. Nos. 60/096,237 filed Aug. 12, 1998 and 60/101,935 filed Sep. 25, 1998. Note that U.S. Pat. No. 6,405,974 has been reissued through application Ser. No. 10/366,652 filed Feb. 14, 2003 and is now reissue patent RE 39,521. All of the above referenced applications and patents are incorporated herein in their entirety by reference.

### GENERAL FIELD OF THE INVENTION

This invention relates to generally cylindrical, preferably hollow core tubular articles that are useful for supporting rolled goods like carpets and plastic film. It more particularly refers to such cores that are light in weight and have unusually high crush resistance.

### BACKGROUND OF THE INVENTION

Cores for all kinds of rolled goods, such as plastic film, carpeting, paper products, and the like, are well known. In many instances, these cores are simply hollow cylindrical rolls of cardboard or other convenient materials. In other cases, these cores may be solid plastic, wood or metal rods.

In one very old patent, U.S. Pat. No. 3,627,221, there is described a decorative end plug for rolled paper, such as newsprint. The end plug is made up of a centrally located opening for receiving an axially disposed shaft, a generally flat, solid, disc like portion 16 disposed radially about the shaft receiving axial opening 18, and a peripheral rim portion 20 disposed radially around the disc portion 16. From a consideration of FIG. 1 of this patent, it appears that a core 12 of the paper roll 10 is intended to fit about the rim portion 20. Put another way, the described end plug is intended to fit within the core of the roll of paper and the shaft (unnumbered) that will support the assembly is intended to pass through the axial opening 18 in the end plug.

The peripheral rim portion 20 of this disclosed end plug appears to be composed of a “U” shaped member that is made up of two concentric elements 26 and 30 that form the arms of the “U”. A series of webs 34 and 36 appear to span the top of the “U”. These webs and the arms of the “U” are so arranged as to form generally triangular areas or cells 38. This end plug is intended to help to support the ends of the paper roll on its cylindrical paper core. The depicted end plug is generally flat in cross section and is not disclosed to pass axially all the way through the paper roll or its cylindrical paper core. In fact, this end plug is characterized by having a diameter that is substantially larger than its depth, that is, it is a disk-like shape rather than a tube-like shape. The end plug is said to taper inwardly in thickness from its periphery toward the central opening in order to increase its resiliency during its insertion into the end of the paper toll. The '221 patent says that the depicted flat, disc like end cap may be made of molded plastic, such as polyethylene. It is clear that the depicted end cap is not suited to have paper or other flat goods rolled up on it, but is only suited to be inserted into the end of an already made roll of paper or the like. Despite the support that the end plug of the '221 patent may give to the ends of the internal tubular paper central tube, the paper core 12 must be self supporting and able to withstand the weight of the paper rolled thereon over substantially the whole of its length.

It is to be noted that the '221 patent states that the disclosed end plug is intended to help protect the already made roll from damage during loading and unloading and during transit, not during the making of the roll of paper. This distinguishes that end plug from the core structure of the instant invention which is intended for use in creating the roll of flat goods, especially shrink wrap plastic film. The crush stress that is applied to the core by shrink wrap plastic film is substantially greater that what is applied by newsprint, and this stress increases with the amount of shrink wrap film that is wound on the central core. It increases further with increases in the shrinkability of the film being wound and with increases in the speed of winding of the film. Therefore, modern wrapping techniques frequently use solid cores to support most industrial sized rolling of flat goods, from carpet to plastic film.

Solid wood, plastic or steel rollers are quite heavy and add to the shipping costs of the material rolled on them. Further, solid cores of these materials are expensive and, although efforts at recycling have been attempted, they have not met with great success. The cost of the cores must then be added to the cost of the material that is wrapped on the cores. It is obvious that making the cores hollow and thin walled will substantially reduce their weight, and therefore their cost, and will also reduce the weight of the entire rolled product whereby reducing shipping costs as well. The problem with using hollow cores, however, is that hollow tubes necessarily have lower crush strength than solid cylinders of the same diameter and material. Further, and the thinner the walls of hollow cores, the less is their crush resistance. It has therefore been thought that the tradeoff between the weight and cost of the core and the crush strength of the core was just something the art had to accept, with the proper core selected for each application.

### OBJECTS AND DESCRIPTION OF THE INVENTION

It is an important object of this invention to provide a novel hollow core tubular article

It is another object of this invention to provide a novel tubular article that can be used for, among other things, supporting rolled goods thereon.

It is a further object of this invention to provide such a tubular article that is lighter in weight than previous similar articles, and yet has a substantially higher crush resistance than has been achieved in the past.

It is a still further object of this invention to provide such a tubular article that has sufficient radial crush strength to support the stress of substantial quantities of flat goods, particularly shrink wrap plastic film, thereon.

It is another object of this invention to provide a method of making relatively inexpensive, crush resistant hollow tubes that are suited for use as cores in supporting rolled flat goods.

It is a still further object of this invention to provide novel means for improving the roundness of tubular articles, either hollow tubular articles or solid cylindrical articles that are made by an extrusion method.

It is a still further object of this invention to provide an improved method of making tubular articles of substantial length that have more consistent diameters than has been achievable in the past.

Other and additional objects of this invention will become apparent from a consideration of this entire specification, including the drawing hereof.

In accord with and fulfilling these objects, one aspect of this invention is a seamless, helical, elongated, hollow tubular element, sometimes referred to herein as a composite tube, comprising a smaller diameter inner, generally hollow, helical tubular element and a larger diameter outer, hollow, helical tubular element radially spaced from the inner tubular element. These two tubular elements define an annular space. A plurality of helical ribs is disposed in this annular space seamlessly integral with, and in supporting relationship to, the inner and outer tubular elements. Next adjacent helical ribs taken together with the portions of the inner and outer tubular elements that they intercept comprise truss cells, each comprising a two next adjacent helical ribs and respective intercepted portions of inner and outer helical elements. These helical truss cells enable the inner and outer helical elements to maintain their radial spacing from each other and provide crush resistance to the composite tubular article. Preferably there is a plurality of such helical ribs/truss cells disposed between, and seamlessly integral with, both the inner and outer helical wall elements. These plural ribs are suitably equally spaced from each other about the periphery of the inner and outer helical tubular elements. Most preferably, these helical ribs are substantially equidistantly spaced apart circumferentially within the annular area between the inner and the outer tubular elements.

According to one aspect of this invention, these plural webs or ribs are preferably disposed in locations such that at least some of them, and preferably all of them, contact, and support, the radial spacing of both the inner and outer helical tubular elements, respectively, at locations where other such ribs also contact the inner and outer tubular wall elements, respectively. Put another way, each helical rib seamlessly contacts the inner and outer tube and, at the same time, contacts, or at least is very close to, the point where the next adjacent rib also contacts either the inner or the outer tubular wall, respectively. Thus, according to this aspect of this invention, at least some of the next adjacent ribs are disposed at an angle, other than normal, with respect to the inner and outer tubular wall elements. Thus, each pair of next adjacent ribs together with the intercepted portions of the inner and outer tubular elements form truss cells that are either triangular or trapezoidal in cross section.

In another embodiment of this invention, where the next adjacent ribs are disposed normal to the inner and outer wall elements, the truss cells thus formed are trapezoidal in cross section because the inner wall element has a shorter circumference than does the outer wall element. It is to be noted that even though the ribs are radial in disposition and are positioned normal to the inner and outer wall elements, these ribs are helical in shape as are the wall elements that are intercepted by these ribs. Thus, the entire structure is helical and seamless. It is further to be noted that it is considered to be within the scope of this invention to provide helical truss cells of different cross sectional configuration in the same tubular structure. Thus, some of the next adjacent ribs may be disposed normal to the inner and outer tubular wall elements and some of them may be disposed at angular relationship to the relevant inner and/or outer wall elements. Thus some of the relevant truss cells may have triangular cross section and others may have trapezoidal cross sections. Some of the trapezoidal truss cells may have cross sectional configurations that approach rectangular, while other of the trapezoidal truss cells may have may have cross sectional configurations that approach triangular. In all cases, at least one of the walls of these truss cells is curved because it is derived from a portion of the inner or outer tubular wall element. Thus the geometric shape of the truss cells is never exactly trapezoidal or triangular. However, it is convenient to refer to these truss cells by the name of their closest geometric figure.

In a preferred embodiment of this invention, each helical rib contacts both ribs that are next adjacent on each side thereof at the same time as it contacts both the inner and outer tubular helical wall elements, respectively, or is at least proximate to both of these next adjacent ribs at the point where it contacts both the inner and outer helical wall elements, respectively. Thus in the embodiment where there are a plurality of ribs disposed about the annular space between the inner and outer wall elements, each rib forms a wall of two next adjacent truss cells.

It is a preference in the structure of the composite tube of this invention to slightly space the ribs apart at the points where they intersect the helical, arcuate wall of one of the tubular elements. In this manner, the preferred cellular structure, having a truss cross section that approximates a trapezoid that approaches a triangle in cross section, is formed. The slightly trapezoidal shape of the spacing truss cells has been found to be desirable and an improvement over the triangular truss cell cross section because, when the composite tube of this invention having generally trapezoidal cellular cross section is made by extrusion of molten plastic or metal material, an excess of the extruded material does not accumulate at the point where the ribs contact the inner or outer tubular wall elements, respectively.

It is preferred that each rib extend the whole length of the composite tubular article of this invention, and that it contact be adhered to and support both of the inner and outer tubes, respectively, along its entire length. However, this is not an absolute requirement. The ribs(s) may be attached to the inner and/or outer tubular elements at intermittent areas so long as the total amount of attachment is sufficient to accomplish the purposes of this invention, that is to maintain substantially consistent spacing between the inner and outer tubes while at the same time providing sufficient radial support to avoid the composite tube being crushed by radial pressure being applied such as by winding a flat form film or sheet material wound thereon.

The ribs can be generally rectangular in cross section, but this geometric shape is not an absolute requirement of this invention. The ribs may have a triangular, trapezoidal, circular, oval or any other desired, cross section. Further, although it is preferred that the ribs be substantially constant in cross section and area over their entire length, the cross sectional area and/or geometry of the rib(s) may change over the length of the composite tube. The geometry and cross section may also, or alternatively, change from rib to rib, as appropriate. Any combination of these parameters is considered to be within the scope of this invention.

The preferred embodiment of this invention is to provide a plurality of helical ribs substantially uniformly radially distributed about the periphery of the outer surface of the helical inner tube (and consequently about the inner surface of the outer helical tube). The cross section of each rib is preferably the same from rib to rib and along the entire length of the ribs. The truss cells formed between the next adjacent ribs and the walls of the inner and outer tubular elements are preferably all substantially triangular or trapezoidal in cross section.

It is well known that triangular shapes are the strongest structural shapes for a given weight and type of material, and that the further the structure departs from a true triangle, the less rigid and strong is the resulting shape. Therefore, the trapezoidal shapes of this embodiment of this invention give up some of their strength in exchange for lighter weight and lower cost (because of less material being used). It is therefore preferred that the length of the smaller leg of the trapezoid (that is a leg that is derived from a portion of either the inner or outer tubular elements) that be no more than about 10% of the length of the longer leg of the trapezoid (that is the leg that is derived from a portion of the other of the inner or outer tubular elements). Of course it will be realized that these trapezoidal legs that are being referred to here are not straight as in the real trapezoid geometric shape, but rather are segments of the arcuate walls of the inner and outer tubes. The truss cells are therefore geometric shapes that approach a trapezoid or a triangle, rather than actually being an exact trapezoid.

It is to be noted that when the cross sectional shape of the truss cells is substantially a small angle trapezoid, that is a trapezoid that approaches triangular, the crush resistance is derived from the geometric shape of the truss cell cross section; that is, resistance to crushing is mainly afforded by the geometric shape of the truss cell cross section. It is also considered to be within the scope of this invention to take greater advantage of the compressive strength of the ribs themselves with or in addition to the crush resistance afforded by the geometric shape of the truss cell cross section by providing some or all of the ribs/truss cells extending radially (that is perpendicular) from both the inner and outer tubular elements.

A further embodiment of this invention takes advantage of both means of increasing crush resistance by providing at least some next adjacent ribs that alternate between being normal to the inner and outer tubular elements and being angularly disposed relative to the inner and outer tubular elements. In this embodiment of this invention, it is preferred that at least some of the angularly disposed rib elements extend between the point where two successive normal ribs intersect with the inner and outer tubular elements, respectively. Thus one may consider this structure as sort of an “N” shape with the open ends of the “N” being enclosed by the relevant arcuate sections of the inner and outer tubular elements, respectively. It is considered to be within the scope of this invention for the slanted rib(s) to intersect the inner and/or outer tubular element at the same place as, or a short distance from, the point where the normal rib(s) intersects the inner and/or outer tubular elements.

Where a rib is disposed normal to the inner and outer tubular elements, it acts as the web section of an “I” beam in support of the relative spacing of the inner and outer tubular elements. This is a very strong structure requiring only a relatively small amount of material in the rib. This structure is strengthened to an even greater extent by alternating radial and slanted rib element. The radial rib elements get their strength from acting like an “I” beam as well as from being part of a triangular or trapezoidal structure. The strength of such a structure is therefore substantially enhanced.

The inner and outer walls are preferably concentric, but they may depart from absolute concentricity in that one or the other may be eccentric, that is not of circular cross section. In the alternative, the tubular walls may be out of concentricity by both of the tubular walls being of circular cross section but having centers/axes that are not coincident. The ribs should preferably be of such a size and shape as to follow any eccentricity that may exist. The term “concentric” will be applied to the inner and outer tubes of this invention in this specification and the claims appended hereto in this broad sense, that is sufficiently concentric to accomplish the purposes of this invention, but not necessarily absolutely concentric. The term, “concentric” should therefore not be taken as a structural limitation but rather as a description of the relationship between the tubular walls as being inner and outer.

Thus the cross sectional shape of the inner and outer walls of the tubular elements of this invention may be the same or different. Their cross sections may be any shape that suits the ultimate use to which the core will be put, such as circular or elliptical for example. Of great important to the article of this invention is the disposition of longitudinal ribs between, and seamlessly joining to, the inner and outer tubular elements, and supporting both of them. The combination of the longitudinal ribs (that may be normal or slanted or a combination of both) and the inner and outer tubular walls creates a truss cell structure that withstands substantially greater crushing forces than would either the inner or the outer walls by themselves, or even a single wall having the thickness that is equal to the combined thickness of the inner and outer tubes.

These above described helical, ribbed hollow wall tubular structures have performed very well in tests conducted to determine their crush resistance. It has been found that the helical, “off-radial” ribbed (trapezoidal or triangular) truss structure is substantially stronger and more crush resistant than a hollow multi-wall structure of the same weight with only spaced radial ribs that is not helical. It has been found that when the bi-wall composite tube of this invention is squeezed between flat plates, such as is approximated by closing the jaws of a vise, the mode of crush failure of the structure is a buckling of some of the inner and outer tube wall segments between the ribs that are proximate to the jaws of the vise. The forces acting on the hollow wall structures when pressed between flat, diametrically opposed plates is to compress the outer wall of the portions of the structure that are in contact with the pressure plates of the vise, and to compress the inner wall in those locations that are 90° from the points where the pressure is being applied. It is these specific inner and outer wall elements, respectively, that buckle first. Where the ribs are generally longitudinal, rather than helical, in disposition, the wall buckling progresses all the way down the length of the composite structure of this invention between the ribs as aforesaid. There is no structure available to stop the buckling process.

According to a most preferred aspect of this invention, therefore, the structure as a whole, and especially the truss structures and their ribs (radial or off radial), is a helix. In this manner, a buckling of any one portion of the structure, such as between rib elements, by reason of pressure being applied in the radial direction, such as between flat plates, will not have an unimpeded longitudinal path from one end of the multi-walled tube structure of this invention to the other. Rather, as the structure, including the truss cells, progresses helically about its axis, places are formed where helical rib elements will be disposed directly in the path of the pressure being applied by the opposing flat plates as aforesaid, and will thereby act as a stop to longitudinal progression of buckling.

An unexpected advantage of composite helical cylindrical structure of this invention is that the cylindrical structure unobviously shows better consistency of circumferential diametral dimension, i.e. roundness, as compared to composite cylindrical structures comprising ribs and other elements that are merely longitudinal, and not helically disposed, assuming the manufacturing precision is the same in both cases. In the case of ribbed helical tubes of this invention, these same considerations apply regardless of the cross sectional shape of the ribs, or their being radial or off-radial, as has been described herein.

Producing helical, ribbed, two walled unitary seamless cylindrical structures is not an easy accomplishment. Conventionally, the inner and outer tubular elements are extruded in a linear direction, with the inner and outer tubes being generally concentric to each other. The rib forming material is conventionally extruded between, and seamlessly combined with, the inner and outer wall elements. The method and apparatus needed to produce such a unitary, seamless, helical, cylindrical multi-walled tube is required to extrude the molten molding material, such as plastic, into a single extrudate that has its helical shape imposed within the space between the extruder and the cooling/solidifying means. There are two ways of imparting this helical configuration to the molten extrudate. This can be accomplished by extruding the molten plastic through a complicated rotating die that imparts the required helical structure to the radially spaced apart inner and outer tubular elements and to the ribs there between as the extrudate leaves the die lips and prior to subjecting the extrudate to a cooling/solidifying operation. A viable alternative is to extrude the molten plastic through a conventional fixed die that has the necessary attributes to form the desired extrudate. Downstream of the cooling/solidifying station, and after the tubular structure has hardened into a hollow cylinder, the solidified structure can be pulled downstream and simultaneously twisted. The imparted twist will proceed upstream along the solidified, multi-walled tube past the cooling station and impart its twist to the molten extrudate as it emerges from the extruder die. Thus, the process of forming the multi-walled, unitary, helical tubular structure according to this invention requires that the helical structure must be imparted into the extrudate before it becomes solidified. However, this helical configuration can be imparted by acting on the molten extrudate from either the perspective of the upstream die or from the perspective of the solidified downstream tube or even by doing both.

In one aspect of this invention, immediately upon the extrudate emerging from the extruder die, and before the extrudate has had an opportunity to harden, such as by cooling, the portion of the multi-walled composite tube that has been cooled and hardened is rotated at a rotational speed sufficient to turn the composite tube, as well as the ribs therein to form them into a helix of the desired flight length and pitch. The speed of extrusion and the speed of turning of the extrudate must be closely coordinated to insure that the helical structure including the integral helical ribs that may be normal or slanted with respect to the inner and outer tubular elements are properly formed.

In making a helically shaped, multi-walled, tubular product, it is necessary to provide relative rotation of the extrudate as it exits the die and is pulled downstream while it is solidified. This can be done in either of two ways: rotate the die while pulling the extrudate straight out in an axial direction, or keep the die stationary and rotate or twist the extrudate as it is pulled away from the die. In the instant situation, there are benefits to be had by proceeding either way. It is preferred to maintain the die in a non-rotating condition and rotate the extruded composite tube, and pull it in a downstream direction, after it has been cooled and solidified. By twisting the solidified tube and pulling it downstream, the molten extrudate is formed into a helical structure with helical ribs and helical inner and outer tubular elements. It is pointed out that this same thing can be accomplished by pulling the solidified tube axially downstream while the rotating complex die is simultaneously twisting the molten extrudate so that the extrudate is formed into a helical structure before it is cooled and solidified.

As an adjunct to the formation of a helical multi-walled tubular structure, a novel puller/twister has been developed as part of this invention. This novel puller/puller comprises at least one belt wound helically around the solidified tubular product. As the belt is driven along a helical path, it pulls the solidified tube downstream and simultaneously rotates it. This dual motion is translated upstream to the molten extrudate and causes the molten extrudate to be twisted and pulled downstream whereby converting the cylindrical molten extrudate into a helical molten extrudate that is then cooled and solidified.

One difficulty that has been encountered by this operation is that in rotating the solidified tube, the belt inherently applies sideways forces that tend to bend the tube as well as rotate it and pull it downstream. According to another aspect of this invention, this problem is solved by applying at least one additional, longitudinally spaced helically wound belt that exerts downstream pulling force in the same direction and a rotational force in the same direction but acts on the multi-walled solidified tube from a position that is angularly disparate with respect to the first belt. For example, if a two belt twisting/pulling operation is being carried out, the two helically acting belts would act on the cooled, solidified tube from positions that would be about 180° apart. In the case where three belts were being employed, they would preferably be disposed 120° apart. This tends to equalize the transverse forces that are being applied by the twisting/pulling belts. This operation has the added advantage of applying a generally uniform radial squeeze so there is little or no flattening of the tube during the pulling and twisting.

It is considered to be within the scope of this invention to produce the multi-walled, helically configured, internally ribbed, tubular structure by using a combination of imparting the desired helical structure by employing both a rotating complex extrusion die that imparts the helical structure in the extrudate by the turning action of the die and a down stream puller/twister. When operating in this matter, two process events are used to make it possible to fine tune the configuration of the helical structure and at the same time insure that the relationship between the ribs and the inner and outer tubular elements creates the most desirable structure.

The extrudate material may be plastic or metal. Polyethylene and polystyrene have worked well but there does not appear to be any specific limitation on the nature of the material being used to make the multi-wall cylindrical structures of this invention so long as it is reasonably extrudable and moldable within the space between the extruder die and the cooling/solidifying operation. The extrudability of the material and the moldability of it in the short time between extrusion and cooling/solidification is the prime consideration. Any material that extrudes well and solidifies fairly rapidly, but not instantaneously, will serve as a suitable material from which to make the multi-wall helical tubes of this invention. If needed, auxiliary heat may be applied to maintain the extruded tube at the proper temperature to permit it to be rotated to form the helical structure.

It is considered to be within the scope of this invention to make the inner and outer tubular elements of different materials, respectively. The ribs may be made of the same material as either the inner or the outer tube, or of a completely different material. In any case, the final structure needs to be a seamless, helical, unitary structure

The above and the following descriptions of the instant invention in all of its aspects has been exemplified by one inner and one outer wall element, respectively. It should be clear that this is not a limitation on the scope of this invention, but rather is illustrative thereof. A seamless, unitary, helical, tubular structure with a succession of more than two radially spaced apart walls is contemplated by this invention. Further, this invention contemplates producing a multi-wall helical structure that is cylindrical but not hollow. Thus, the inner wall element discussed herein may be a helical solid that is joined to a radially spaced apart, larger diameter, tubular element by means of rib elements as aforesaid.

### BRIEF DESCRIPTION OF THE DRAWINGS

FIG. 1 is a perspective view of a hollow two walled tubular article with radial ribs forming generally large angle trapezoidal truss cells;

FIG. 2 is a perspective view of a hollow two walled tubular article with “off-radial” ribs forming generally triangular truss cells;

FIG. 3 is a perspective view of a hollow two walled tubular article with helically disposed “off-radial” ribs forming triangular truss cells;

FIG. 4 is a perspective view of a hollow two walled article with “off-radial” ribs arranged to form generally small angle trapezoidal truss cells;

FIG. 5 is a front elevation of an apparatus suited to draw tubular extrusions into a small angle triangular helical form suited to forming the product shown in FIG. 3;

FIG. 6 is a front elevation of an alternative means of producing the product embodiment of this invention that is shown in FIG. 3;

FIG. 7 is similar to FIG. 5 but showing a plurality of pulling/twisting belts; and

FIG. 8 is similar to FIG. 6 but also showing a plurality of belts.

### DETAILED DESCRIPTION OF THIS INVENTION

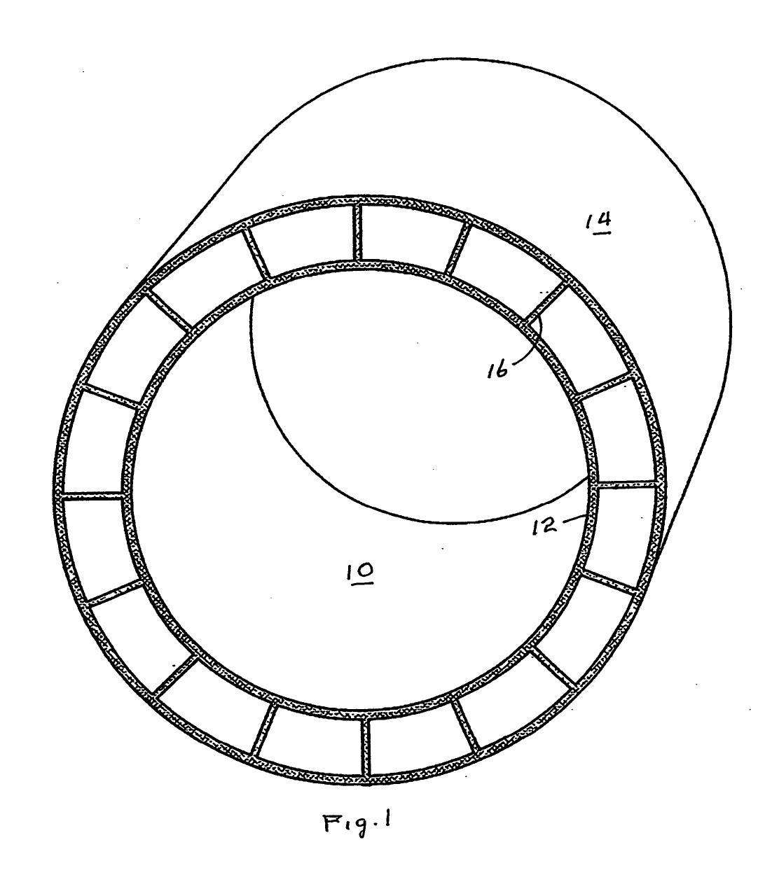

Reference will now be made to the drawing, wherein like parts have been given like reference numbers. Referring to FIG. 1, a composite helical tube 10 is made up of an inner tubular element 12, an outer tubular element 14 and a plurality of ribs 16 there between forming truss cells having a wide angle trapezoidal cross section.

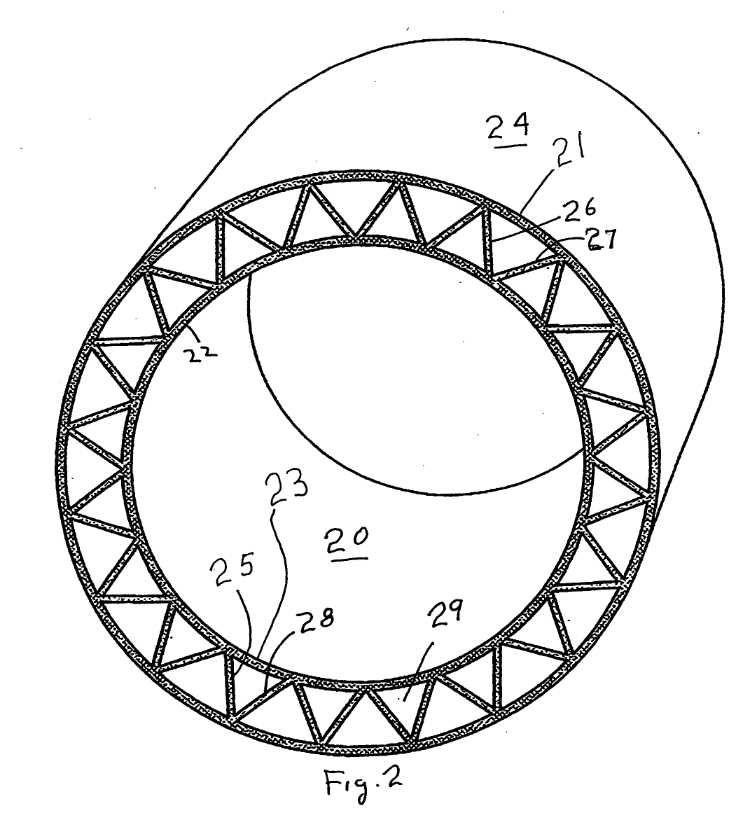

Referring to FIG. 2, a modified composite tube 20 of this invention is made up of an inner tubular element 22, an outer tubular element 24, and a set of generally triangular truss cells 29 each comprising “off radial” ribs 26 and 27, and 25 and 28, respectively, and intercepted portions of the inner tubular element 23 or, respectively, the outer tubular element 21. Note that the triangular truss cell 29 is made up of a combination of a portion 23 of the inner tubular element, or of the outer tubular element 21, respectively, and two sets of ribs 25 and 28, and 26 and 27.

Referring to FIG. 4, a further modified composite tube 40 of this invention is made up of an inner tubular element 42, an outer tubular element 44, and a series of left and right handed alternating “off-radial” ribs 46 and 48, respectively. Note that the left and right handed ribs contact and are joined to the inner and outer tubular elements, respectively, out of contact with each other. This is to be compared to the structure shown in FIG. 2 where the left and right handed ribs contact each other at the same place as they contact the inner and outer tubes, respectively. In FIG. 4, the truss cells 49 that have thus been created have a small angle, generally trapezoidal cross section.

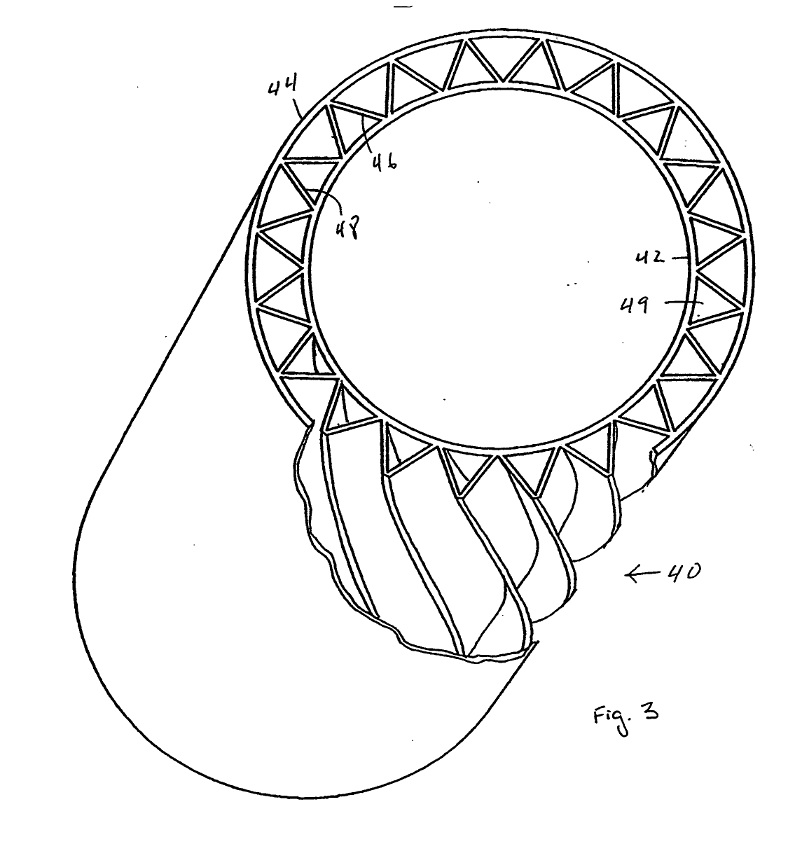

Referring to FIG. 3, there is shown a composite tube 20 of this invention that has a cross section that is similar to that shown in FIG. 2. Part of the outer tubular element of the structure 20 shown in FIG. 3 has been broken away to show the helical structure of this product. The composite tube 20 comprises an inner tubular element 42, an outer tubular element 44 and slanted ribs 46 and 48. The combination of these slanted ribs 46 and 48 form part of a generally triangular truss cell such as shown at 49,

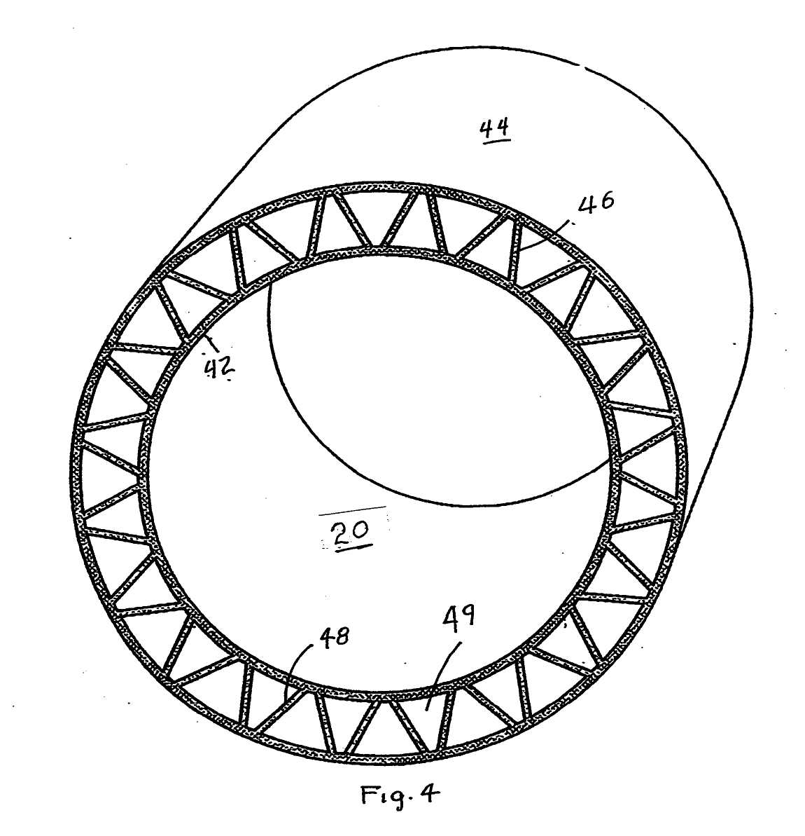

Referring to FIG. 5, there is shown an apparatus for employing one technique of forming the composite tube of this invention into a helical structure. The extruded composite tube 50 is proceeding from right to left in this figure. A driven belt 52 is relatively tightly wrapped around the composite tube 50 in a helical configuration, and means 54 are provided for driving the belt whereby drawing the tube in a downstream direction while at the same time twisting the tube. The combination of simultaneous drawing and twisting causes an upstream, molten extrudate to become a helical configured structure as depicted in FIG. 3.

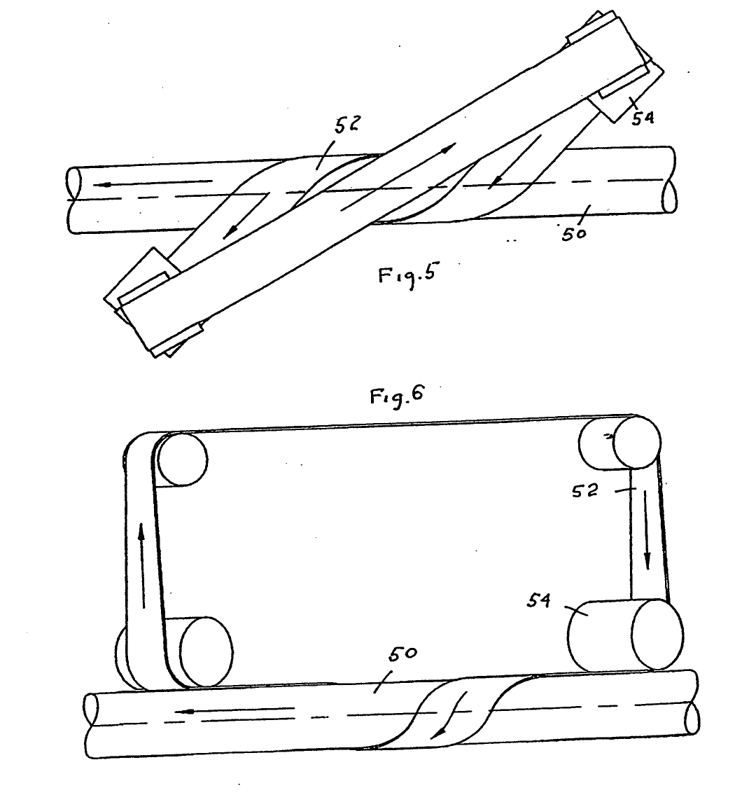

Another embodiment of the means for twisting the extruded composite tube is shown in FIG. 6. In this figure, the belt driver 54 is shown to be in a different position from the position of the belt driver shown in FIG. 5. However, the operation of both embodiments is substantially the same. The belt 52 is helically wrapped around the composite tube 60 whereby driving the tube from right to left and in a counterclockwise direction (when viewed with the composite tube traveling away from the point of view).

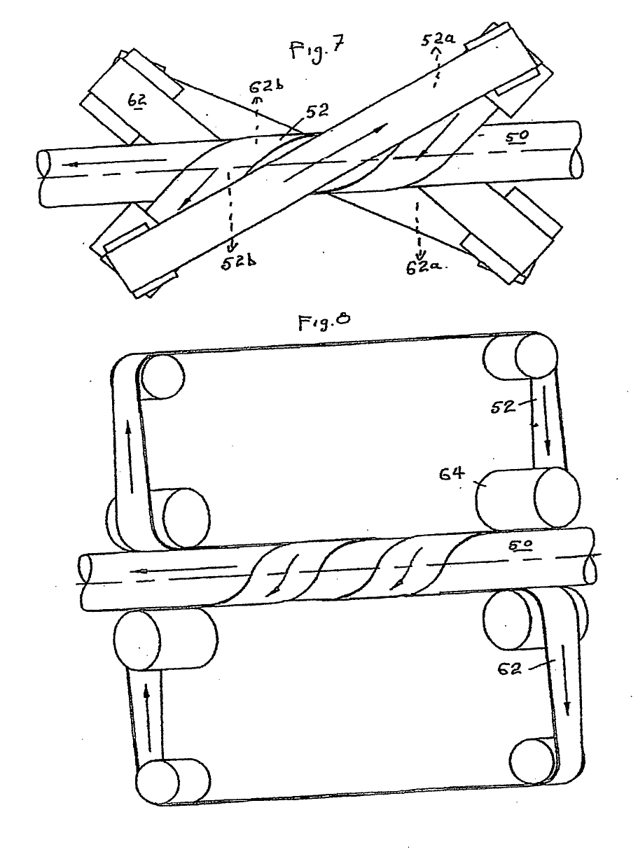

FIGS. 7 and 8 show an improved apparatus for pulling a tubular article 50 downstream, that is from right to left in the drawing and simultaneously twisting that article. The depicted apparatus has two belts in the depicted assembly. The first belt 52 is the same as depicted in FIGS. 5 and 6. The second belt 62 acts in the same way as the first belt 52 but it contacts and applies movement pressure to the tube 50 in a position that is offset from the location of the belt 52. It is to be noted that, as shown in FIG. 7, the first belt 52 is made up of a driving section 52b and a return section 52a. The second belt also has a drive section 62b and a return section 62a. Note that the two belts 52 and 62 contact the tubular structure 50 at different points and therefore tend to strike a balance minimizing or preventing sideways deforming the tubular structure 50.

The nature of the material of the driving belt is not particularly critical. Its surface should have a sufficient coefficient of friction relative to the material of the extruded composite tube that it will be able to drive the tube without crushing or marring its surface. In most instances, the surface of the drive belt will be smooth so that it does not mar the surface of the composite tube. However, the driving belt may be used to impart a profiling to the surface of the composite tube.

What is claimed is:

1. A seamless, unitary, helical structure comprising at least one axially elongated, substantially rigid, inner cylindrical element having an outwardly directed substantially cylindrical surface, at least one axially elongated, substantially rigid outer tubular element having an inwardly directed substantially cylindrical surface radially spaced from said outwardly directed surface, and a plurality of substantially rigid rib elements disposed between and seamlessly contiguous with said inwardly directed surface and said outwardly directed surface whereby forming said seamless, unitary, helical structure,
wherein at least one next adjacent pair of said ribs, together with portions, respectively, of said inner and outer element surfaces intercepted by and contiguous with said pair of ribs, constitute helical truss cells having a generally trapezoidal cross section at least over a portion of said structure.

2. A helical structure as claimed in claim 1 wherein said inwardly directed and said outwardly directed surfaces are concentric over at least a portion of said structure.

3. A helical structure as claimed in claim 1 wherein at least some of said ribs are disposed substantially normal to said inwardly and outwardly directed surfaces, respectively.

4. A helical structure as claimed in claim 3 wherein at least some rib elements disposed next adjacent to each other taken together with sections of said inner and outer elements intercepted by said rib elements comprise truss cells that are cylindrically trapezoidal in cross section and wherein the length of the portion of said inner cylindrical element intercepted by said next adjacent rib elements is shorter than the portion of said outer tubular element intercepted by said next adjacent rib elements.

5. A helical monolithic structure comprising an inner cylindrical element having a substantially cylindrical outwardly directed wall, an outer tubular element having an inwardly directed wall, and a plurality of ribs at least some of which are contiguous with and in seamless supporting relationship to both said inwardly and outwardly directed walls, wherein at least some of said ribs are normal to said inner and outer wall elements and are seamlessly integral with both of said inwardly directed and outwardly directed surfaces, respectively, so as to form at least one truss cell having a generally trapezoidal cross section, said truss cell comprising two next adjacent helical rib elements, a portion of said inner cylindrical element intercepted by said ribs and a portion of said outer tubular element wherein said entire structure, comprising said inner member, said outer member and integral truss cells are so configured that the entire structure is helical, and wherein some of said trapezoidal truss cells comprise a portion of said inner cylindrical element that is longer than the portion of said outer tubular element.

6. A helical structure as claimed in claim 5 wherein all of said ribs are contiguous with, and an integral part of, both of said inwardly directed and outwardly directed surfaces, respectively.

7. A helical structure as claimed in claim 1 wherein at least some of said ribs are seamlessly integrated with at least one of said surfaces, respectively, at a location that is spaced from the location where a next adjacent rib is seamlessly integrated with at least one of said surfaces so as to, together with the inwardly directed and outwardly directed surfaces disposed between said rib integration points, respectively, form truss cells with a generally trapezoidal cross section.

8. A helical structure as claimed in claim 1 wherein said trapezoidal cross section truss cells extend the entire longitudinal axial length of said structure.

9. A helical structure as claimed in claim 1 wherein said inner and outer elements are substantially concentric and each has a substantially circular cross section.

10. A helical structure as claimed in claim 1 which is extruded as a monolith.

11. A helical structure as claimed in claim 1 comprising a plurality of said truss cells substantially equidistantly circumferentially distributed about the internally directed circumference of said outer element.

12. A helical structure as claimed in claim 1 consisting essentially of a solidified monolithic extrudate.

13. A helical structure as claimed in claim 1 wherein the intersection between said ribs and said surfaces occurs during extrusion and is seamless.

14. A helical structure as claimed in claim 1 wherein at least some of said ribs are substantially rectangular in cross section.

15. A helical structure as claimed in claim 1 wherein said inner element is tubular.

16. A helical structure as claimed in claim 1 comprising polyethylene.

17. A helical structure as claimed in claim 1 comprising polystyrene.

18. A helical structure as claimed in claim 1 wherein said ribs are not substantially thicker than one of said inner or outer walls.

19. A method of making the structure as claimed in claim 1 comprising:
feeding a molten stream of moldable plastic to and through an extrusion die comprising a rotatable inner arcuate die portion that corresponds to said inner cylindrical element, a rotatable outer arcuate die portion that corresponds to said outer tubular element and is radially spaced from said rotatable inner die portion, and a plurality of rotatable die portions that correspond to said rib elements,
wherein said rib element die portions seamlessly communicate with said inner and outer arcuate dies;
while feeding said stream of moldable plastic through said extrusion die, simultaneously rotating all of said rotatable die portions together to thereby extrude a seamless, helical, unitary, molten extrudate structure comprising an inner, helical, cylindrical element, a radially spaced apart outer, helical, tubular element and a plurality of helical truss cells comprising at least two next adjacent helical ribs and portions of said inner and outer elements intercepted by said ribs; and
moving said molten helical extrudate downstream while cooling the same an amount sufficient to solidify the extrudate whereby freezing said helical form into said structure.

20. An apparatus for carrying out the method as claimed in claim 19 comprising:
an extruder;
a rotatable extrusion die assembly operatively associated with said extruder, wherein said extrusion die comprises an inner die portion, an outer die portion radially spaced from, and concentric with, said inner die portion, and a plurality of intermediate extrusion die portions in operative contact with both said inner and outer die portions;
means to feed moldable plastic to said extruder;
means to melt said plastic and to pass said molten plastic through said extrusion die assembly;
means to rotate said extrusion die assembly as a unit while passing said molten plastic through said extrusion die assembly to thereby form a molten extrudate in the shape of a helix without substantially twisting said extrudate;
means to move said extrudate downstream from said extrusion die assembly; and
means to cool said molten extrudate while moving it in a downstream direction an amount sufficient to freeze said extrudate into said helical configuration.
